(19) United States
(12) Patent Application Publication
(10) Pub. No.: US 2025/0198510 A1
(43) Pub. Date: Jun. 19, 2025

(54) DRIVE UNIT FOR A VEHICLE

(71) Applicant: ZF Friedrichshafen AG, Friedrichshafen (DE)

(72) Inventors: Marcel Störkle, Ravensburg (DE); Dominik Erny, Friedrichshafen (DE); Rayk Gersten, Friedrichshafen (DE); Andreas Graf, Stockach (DE); Maximilian Scheufler, Salem (DE); Bernd Lutz, Uhldingen-Mühlhofen (DE)

(73) Assignee: ZF Friedrichshafen AG, Friedrichshafen (DE)

(21) Appl. No.: 18/980,053

(22) Filed: Dec. 13, 2024

(30) Foreign Application Priority Data
Dec. 14, 2023 (DE) 10 2023 212 686.9

(51) Int. Cl. F16H 63/32; F16H 57/02; H02K 7/00; H02K 7/116

(52) U.S. Cl. CPC F16H 63/32; H02K 7/006; H02K 7/116; F16H 2057/02034

(57) ABSTRACT

A vehicle drive unit includes an electric motor with a rotor shaft, a transmission with at least a first shaft and a shift element arranged radially within the rotor shaft. An elastic spring element is arranged on the shift element, and a guide element is arranged spatially between the rotor shaft, the elastic spring element, and the shift element and configured to guide the shift element during a shifting operation. The shift element is arranged to connect at least the first shaft to the rotor shaft in a rotationally fixed manner in a first shifting position to feed a drive power from the electric motor to the transmission, where the elastic spring element is arranged for centering the shift element in the rotor shaft in a no-load state of the electric motor and enables a compensating movement of the shift element in the rotor shaft in a loaded state.

### RELATED APPLICATIONS

This application claims the benefit of and right of priority under 35 U.S.C. § 119 to German Patent Application no. 10 2023 212 686.9, filed on 14 Dec. 2023, the contents of which are incorporated herein by reference in its entirety.

### FIELD OF THE DISCLOSURE

The invention relates to a drive unit for a vehicle comprising an electric motor and a transmission with a shift element. The invention also relates to a vehicle with such a drive unit.

### BACKGROUND

For example, DE 10 2019 205 747 A1 discloses a drive train with a transmission comprising an input shaft, a first output shaft, a second output shaft, a first planetary gear set, and a second planetary gear set connected to the first planetary gear set. The planetary gear sets each comprise several elements. The transmission also includes a third planetary gear set comprising three elements and two shift elements. A first shift element is designed to lock the third planetary gear set by torsionally connecting two of its elements. A second shift element is designed to fix a first element of the third planetary gear set to the rotationally fixed component.

It is generally known that a shift element that couples two shafts together can rattle in a no-load state of the shafts during rotation due to tilting in the tooth engagement. As soon as a load, in particular a torque, is applied, the shift element is braced and centered via the tooth engagements so that there is no more rattling.

### SUMMARY

The object of the present invention is to provide an alternative drive unit with transmission and shift element for a vehicle. In particular, rattling of the shift element in a no-load state should be prevented. The problem is solved by a drive unit with the features disclosed herein. Advantageous embodiments will emerge from the following description, the figures, and the claims.

A drive unit according to the invention for a vehicle comprises an electric motor with a rotor shaft, a transmission with at least a first shaft and a shift element which is arranged radially inside the rotor shaft, an elastic spring element which is arranged on the shift element, and a guide element which is arranged spatially between the rotor shaft, the elastic spring element and the shift element and is set up to guide the shift element in the rotor shaft during a shift operation, wherein the shift element is arranged to connect at least the first shaft to the rotor shaft in a rotationally fixed manner in a first shift position in order to feed a drive power of the electric motor into the transmission, wherein the elastic spring element is arranged to center the shift element in the rotor shaft in a no-load state of the electric motor and to enable a compensating movement of the shift element in the rotor shaft in a loaded state of the electric motor. For example, the elastic spring element is designed as a quad ring, i.e., a round cord ring with an essentially square cross-sectional area.

In other words, the elastic spring element has a spring-elastic effect and, through elastic deformation, enables the shift element to be centered in the rotor shaft when the electric motor is in a no-load state on the one band and a compensating movement of the shift element in the rotor shaft when the electric motor is under load on the other. In particular, the spring element is preloaded between the guide element and the shift element so that it can deform elastically when force is applied. This aligns the shift element in relation to the rotor shaft so that the shift element cannot tilt in the no-load state and therefore cannot rattle. In the no-load state of the electric motor, the electric motor is essentially not energized and therefore does not generate any drive power, but is carried along by the first shaft due to the rotationally fixed connection via the shift element with the first shaft.

The guide element, which is preferably made of a plastic with good sliding properties, comes into direct contact with the rotor shaft and is supported by both the spring element and the shift element. This not only reduces wear on the spring element, but also the friction between the shift element and the rotor shaft during a shifting operation.

According to a preferred embodiment, the guide element comes into contact at least partially, in particular temporarily, with the rotor shaft, the elastic spring element and the shift element, wherein the elastic spring element comes into contact with the guide element and the shift element. In a no-load state of the electric motor, for example, the guide element only comes into contact with the spring element and the rotor shaft, as the spring element is essentially not compressed, but only pretensioned between the shift element and the guide element. In contrast, when the electric motor is under load, the guide element comes into contact with the spring element, the shift element and the rotor shaft, for example, wherein the spring element is compressed by the guide element.

In the present case, a “rotor shaft” means a component connected to the rotor of the electric motor in a rotationally fixed manner, in particular a coupling component arranged between the shift element and the rotor, or a shaft arranged between the shift element and the rotor. For the purposes of the invention, a “shaft” is to be understood as a rotatable component of the transmission, via which associated components of the transmission are connected to each other in a rotationally fixed manner or via which such a connection can be established when one of the shift elements is actuated. The respective shaft can connect the components axially or radially or both axially and radially. The respective shaft can also be present as an intermediate piece, via which a respective component is connected radially, for example. The term “shaft” does not exclude the possibility that the components to be connected may be designed in one piece. In particular, two or more shafts connected to each other in a rotationally fixed manner can be designed in one piece.

According to a preferred embodiment, the guide element and the elastic spring element are arranged at least partially in a circumferential groove on the shift element. Preferably, the groove has a first circumferential recess, which is designed to at least partially accommodate the guide element, and a second circumferential recess, which is arranged inside the first circumferential recess and is designed to at least partially accommodate the spring element. Accordingly, the groove consists of two circumferential channels. In particular, the guide element protrudes at least partially radially out of the first recess or the first channel of the groove in order to contact the rotor shaft. In particular, the spring element protrudes at least partially radially out of the second recess or the second channel of the groove in order to contact the guide element. For example, the groove is formed outside a gearing section on the shift element. In particular, the groove is formed axially adjacent to a single gearing section on the shift element and thus only adjoins a gearing section on one side.

According to a preferred embodiment, the guide element and the elastic spring element are designed as a composite ring. The guide element and the elastic spring element are therefore combined into a single component, which simplifies assembly on the shift element in particular. The composite ring thus performs two functions, namely the elastic spring function to center the shift element in the rotor shaft when the electric motor is not under load and to enable a compensating movement of the shift element in the rotor shaft when the electric motor is under load, and a guide function for low-wear guidance of the shift element during a shifting operation within the rotor shaft. For example, the guide element and the elastic spring element are connected to each other with a material bond.

According to a preferred embodiment, the elastic spring element is made of an elastomer and has a restoring force that is greater than the sum of a weight force and an unbalance force of the shift element in order to center a center of mass of the shift element in the rotor shaft. The weight force of the shift element essentially corresponds to the mass of the shift element, wherein the unbalance force is dependent on the speed of the shift element. Axially offsetting the shift element in relation to the rotor shaft creates an imbalance, which is to be compensated for by the spring element in a no-load state of the electric motor by centering the shift element in relation to the rotor shaft. In particular, the elastic spring element and the guide element are arranged off-center on the shift element.

A “shift element” is a shiftable device which, in a closed state, connects two shafts or a shaft and a stationary component to each other in a rotationally fixed manner and, in an open state, decouples the two shafts or the shaft and the stationary component from each other. Two shafts can then rotate relative to each other. According to a preferred embodiment, the shift element is designed as a positive-locking shift element. For example, a positive-locking shift element is designed as a claw coupling. Positive-locking shift elements can increase the efficiency of the transmission due to reduced drag losses. In particular, positive-locking shift elements are more compact and efficiency-optimized and have a cost advantage over friction-locking shift elements.

According to a preferred embodiment, the shift element is designed as a sliding sleeve with several shifting positions and can be moved axially into the respective shifting position by an actuator. For example, the actuator can move the sliding sleeve axially from a first shifting position to a second shifting position, wherein at least one of the shifting positions is provided for initiating a drive power. In particular, one of several shifting positions can be a neutral position for decoupling the rotor shaft. For example, one of several shift positions can be a gear position. In particular, the sliding sleeve has a neutral position axially between two gear positions. Preferably, the sliding sleeve has positive-locking claws that interact positively in the respective gear position with a respective corresponding claw toothing in order to set a rotationally fixed connection between two shafts or a shaft and a stationary component.

According to a preferred embodiment, a shifting fork of the actuator is arranged at a first axial end section of the sliding sleeve, wherein a first gearing section for engagement with the first shaft is arranged at a second axial end section of the sliding sleeve, wherein a second gearing section for engagement with the rotor shaft is arranged at a third section of the sliding sleeve arranged between the first and the second axial end section. In particular, the second gearing section has an increased backlash due to a deposit in the gearing, wherein the elastic spring element centers the shift element in the rotor shaft in a no-load state of the electric motor and compensates for this backlash. For example, the third section is arranged off-center on the sliding sleeve.

According to a preferred embodiment, the drive unit further comprises a second shaft, wherein a third gearing section is provided on the sliding sleeve for engagement with the second shaft and is arranged at a position between the second axial end section and the third section of the sliding sleeve. For example, the first and second gearing sections are arranged on an outer peripheral surface of the sliding sleeve, while the third gearing section is arranged on an inner peripheral surface of the sliding sleeve. In particular, the shifting fork of the actuator engages on the outer peripheral surface of the shift element.

According to a preferred embodiment, the rotor shaft is rotatably mounted on a stationary component via a first bearing, wherein the first shaft is rotatably mounted on the stationary component via a second bearing. For example, the stationary component is a housing or a component that is non-rotatably connected to the housing and thus fixed in a stationary position. In particular, the first bearing is supported on the housing by an inner ring, while the second bearing is supported on the housing by an outer ring. The shift element, the rotor shaft and the first shaft are arranged coaxially to each other, wherein the axial offsetting is also dependent on the coaxiality tolerances of the shafts to be interconnected. These coaxiality tolerances must also be taken into account when designing the elastic spring element.

A vehicle according to the invention comprises at least one drive unit according to the invention. The above definitions and explanations of technical effects, advantages and advantageous embodiments of the drive unit according to the invention also apply mutatis mutandis to the vehicle according to the invention.

### BRIEF DESCRIPTION OF THE DRAWINGS

An advantageous embodiment of the invention is shown in the drawings, wherein identical or similar elements are marked with the same reference symbol. It shows:

FIG. 1: a highly abstracted schematic view of a vehicle with a drive axle comprising a drive unit according to the invention; and

FIG. 2: a highly abstracted schematic view of the drive unit according to the invention.

### DETAILED DESCRIPTION

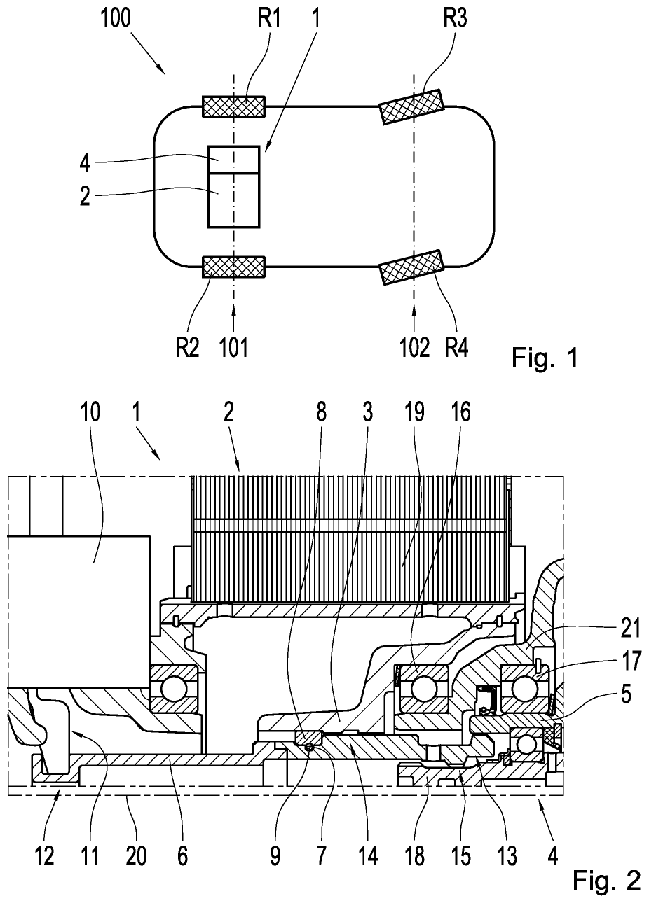

FIG. 1 shows a vehicle 100 with a first axle 101 with two vehicle wheels R1, R2 and a second axle 102 with two vehicle wheels R3, R4. In the present case, the first axle 101 is designed as the rear drive axle of the vehicle 100 and is equipped with a drive unit 1 according to the invention. The drive unit 1 comprises an electric motor 2, which is set up to generate drive power, and a transmission 4. The vehicle 100 is therefore designed as an electric vehicle, i.e., a vehicle that can be driven electrically. The drive unit 1 is arranged transversely to the longitudinal direction of the vehicle and is connected to the vehicle wheels R1, R2 of the first axle 101 with a drive effect. In the present case, no further drive unit is arranged on the second axle 102, i.e., on the front axle of the vehicle 100, which saves costs, weight and installation space. Alternatively, the drive unit 1 can be arranged on the front axle of the vehicle 100 instead of the rear axle. To implement an all-wheel drive system, a further drive unit can be arranged on the second axle 102 and connected to the vehicle wheels R3, R4 of this axle 102 with a drive effect.

FIG. 2 shows the drive unit 1 as shown in FIG. 1. The electric motor 2 has a rotor 19, which is connected to a shift unit 6 of the transmission 4 via a rotor shaft 3, and a stator. The rotor shaft 3 is designed as a coupling body between the shift element 6 and the rotor 19. The shift element 6 is designed as a sliding sleeve. The transmission 4 also has a first shaft 5 and a second shaft 18. The rotor shaft 3, the shift element 6 and the first and second shafts 5, 18 are arranged coaxially to one another, with the shift element 6 being arranged radially within the rotor shaft 3 and the first shaft 5. In the present shifting position, the shift element 6 connects the first shaft 5 to the rotor shaft 3 in order to feed drive power from the electric motor 2 into the transmission 4 when the electric motor 2 is energized.

An elastic spring element 7 and a guide element 8 are arranged in a circumferential groove 9 on the shift element 6, wherein the guide element 8 is arranged spatially between the rotor shaft 3, the elastic spring element 7 and the shift element 6 and is set up to guide the shift element 6 in the rotor shaft 3 during a shifting operation. The guide element 8 is made of a plastic ring with good sliding properties. Furthermore, the elastic spring element 7 is designed to center the shift element 6 in the rotor shaft 3 in a no-load state of the electric motor 2, i.e., when the electric motor is not generating any drive power, and to enable a compensating movement of the shift element 6 in the rotor shaft 3 in a loaded state of the electric motor 2, i.e., when the electric motor 2 is generating drive power.

In the present case, the groove 9 has a first circumferential recess, which at least partially accommodates the guide element 8, and a second circumferential recess, which is arranged within the first circumferential recess and at least partially accommodates the spring element 7. The groove 9 therefore consists of two circumferential channels, namely, a first channel for the guide element 8 and a second channel for the spring element 7. In particular, the guide element 8 partially protrudes radially out of the first recess or the first channel of the groove 9 in order to contact the rotor shaft 3. Furthermore, the spring element 7 partially protrudes radially out of the second recess or the second channel of the groove 9 in order to contact the guide element 8.

The guide element 8 is designed to come into contact with the rotor shaft 3, the elastic spring element 7 and the shift element 6, wherein the elastic spring element 7 is designed to come into contact with the guide element 8 and the shift element 6. In a no-load state of the electric motor 2, the guide element 8 only comes into contact with an outer peripheral surface of the spring element 7 and an inner peripheral surface of the rotor shaft 3, as the spring element 7 is essentially not compressed, but is only elastically pretensioned between the guide element 8 and the shift element 6. In contrast, when the electric motor 2 is under load, the guide element 8 comes into contact not only with the outer peripheral surface of the spring element 7 and the inner peripheral surface of the rotor shaft 3, but also with the outer peripheral surface of the shift element, in particular radially in the groove 9, as the spring element 7 is compressed to the maximum. Due to the radial support of the guide element 8 in the groove 9, the spring element 7 cannot be compressed any further and is therefore protected against damage caused by over compression, i.e., over-deformation.

Preferably, the guide element 8 and the elastic spring element 7 are designed as a composite ring, i.e., as one component, which simplifies assembly on the shift element 6. The shift element 6 is designed as a sliding sleeve with several shifting positions and can be moved axially into the respective shifting position by an actuator 10. In this case, the sliding sleeve has three shifting positions. According to the first shifting position, in which the sliding sleeve is located, the first shaft 5 and the rotor shaft 3 are non-rotatably connected via the sliding sleeve and rotate at a common speed. When the sliding sleeve is axially displaced by the actuator 10, the first shaft 5 and the rotor shaft 3 are decoupled from each other, wherein the sliding sleeve is then in a neutral position and is only connected to the rotor shaft 3 in this second shifting position. If the sliding sleeve is displaced further axially by the actuator 10, the second shaft 18 and the rotor shaft 3 are connected to each other in a rotationally fixed manner and rotate at a common speed, wherein the sliding sleeve is then in a third shifting position.

For axial displacement of the sliding sleeve, a shifting fork 11 of the actuator 10 engages with a first axial end section 12 of the sliding sleeve. A first gearing section for engagement on the first shaft 5 is arranged on a second axial end section 13 of the sliding sleeve. A second gearing section for engagement on the rotor shaft 3 is arranged on a third section 14 of the sliding sleeve arranged between the first and second axial end sections 12, 13. A third gearing section on the sliding sleeve, which is provided for engagement on the second shaft 15, is arranged at a position between the second axial end section 13 and the third section 14 of the sliding sleeve. The groove 9 with the composite ring is formed eccentrically and axially adjacent to the second gearing section on the sliding sleeve. The sliding sleeve extends parallel to an axis of rotation 20 from the actuator 10 through the rotor shaft 3 to the first shaft 5.

The rotor shaft 3 is rotatably mounted on a stationary component in the form of a housing 21 via a first bearing 16, wherein the first shaft 5 is rotatably mounted on the stationary component via a second bearing 17. The first bearing 16 is supported on the housing 21 by an inner ring, while the second bearing 17 is supported on the housing 21 by an outer ring. The shift element 6, the rotor shaft 3 and the first shaft 5 are arranged coaxially to one another, wherein an axial offsetting of the shift element 6 also depends on the coaxiality tolerances of these shafts. The elastic spring element 7 is made of an elastomer with a spring-elastic effect and thus enables an elastic deformation in order to center the shift element 6 in the rotor shaft 3 in a no-load state of the electric motor 2 and to enable a compensating movement of the shift element 6 in the rotor shaft 3 in a loaded state of the electric motor 2. This aligns the shift element 6 in relation to the rotor shaft 3 so that the shift element 6 cannot tilt in the no-load state and therefore cannot rattle. In particular, the spring element 7 has a restoring force that is greater than the sum of a weight force and an unbalance force of the shift element 6 in order to center the center of mass of the shift element 6 in the rotor shaft 3. As soon as a load is introduced into the shift element 6, the spring element 7 is compressed in a controlled manner via the guide element 8 and a compensating movement of the shift element 6 in the rotor shaft 3 takes place.

### REFERENCE NUMBERS

1 drive unit
2 electric motor
3 rotor shaft
4 transmission
5 first shaft
6 shift element
7 elastic element
8 guide element
9 groove
10 actuator
11 transmission shifting fork
12 first axial end section of the sliding sleeve
13 second axial end section of the sliding sleeve
14 third section of the sliding sleeve
15 fourth section of the sliding sleeve
16 first bearing
17 second bearing
18 second shaft
19 rotor
20 axis of rotation
21 housing

1. A drive unit (1) for a vehicle (100), comprising:
an electric motor (2) with a rotor shaft (3);
a transmission (4) with at least one first shaft (5) and a shift element (6) arranged radially inside the rotor shaft (3);
an elastic spring element (7) on the shift element (6; and
a guide element (8) between the rotor shaft (3), the elastic spring element (7), and the shift element (6), wherein the guide element is configured to guide the shift element (6) during a shifting operation in the rotor shaft (3),
wherein the shift element (6) is arranged to connect at least the first shaft (5) to the rotor shaft (3) in a rotationally fixed manner in a first shifting position in order to feed a drive power of the electric motor (2) into the transmission (4), and wherein the elastic spring element (7) is arranged for centering the shift element (6) in the rotor shaft (3) in a no-load state of the electric motor (2) and enabling a compensating movement of the shift element (6) in the rotor shaft (3) in a loaded state of the electric motor (2).

2. The drive unit (1) according to claim 1, wherein the shift element (6) defines a circumferential groove (9) and wherein the guide element (8) and the elastic spring element (7) are arranged at least partially in the circumferential groove (9).

3. The drive unit (1) according to claim 1, wherein the guide element (8) is configured to come to rest at least partially on the rotor shaft (3), on the elastic spring element (7), and on the shift element (6), and wherein the elastic spring element (7) is configured to come to rest on the guide element (8) and on the shift element (6).

4. The drive unit (1) according to claim 1, wherein the guide element (8) and the elastic spring element (7) are configured as a composite ring.

5. The drive unit (1) according to claim 1, wherein the shift element (6) is configured as a sliding sleeve with a plurality of shifting positions and is axially displaceable into the respective shifting position by an actuator (10).

6. The drive unit (1) according to claim 5, wherein a shifting fork (11) of the actuator (10) is arranged at a first axial end section (12) of the sliding sleeve, wherein a first gearing section for engagement with the first shaft (5) is arranged at a second axial end section (13) of the sliding sleeve, and wherein a second gearing section for engagement on the rotor shaft (3) is arranged on a third section (14) of the sliding sleeve arranged between the first and the second axial end section (12, 13).

7. The drive unit (1) according to claim 6, further comprising a second shaft (15), wherein a third gearing section is provided on the sliding sleeve for engagement with the second shaft (15) and is arranged at a position between the second axial end section (13) and the third section (14) of the sliding sleeve.

8. The drive unit (1) according to claim 1, wherein the rotor shaft (3) is rotatably mounted on a stationary component via a first bearing (16), and wherein the first shaft (5) is rotatably mounted on the stationary component via a second bearing (17).

9. The drive unit (1) according to claim 1, wherein the elastic spring element (7) is formed from an elastomer and has a restoring force which is greater than the sum of a weight force and an unbalance force of the shift element (6) in order to center a center of mass of the shift element (6) in the rotor shaft (3).

10. A vehicle (100) comprising at least one drive unit (1) according to claim 1.
